(19) United States
(12) Patent Application Publication
(10) Pub. No.: US 2007/0137467 A1
(43) Pub. Date: Jun. 21, 2007

(54) Portable media player

(75) Inventors: Wong Hoo Sim, Singapore (SG); Pei Ling Koh, Singapore (SG); Zi Kai Koh, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/313,119

(22) Filed: Dec. 19, 2005

(51) Int. Cl. G10H 7/00

(52) U.S. Cl. 84/645

(57) ABSTRACT

There is provided a portable media player including: a non-volatile memory; a decoder for playing back media files stored in the memory; a display unit for displaying information from the media files stored in the memory; a MIDI synthesizer coupled to the processor; a sound input for passing sound signals through an analog-digital converter and subsequently, the synthesizer. There is also a sound output for transmitting sound signals from the synthesizer; and a port for the coupling of a sound composition apparatus to the media player. A method for composing music using the portable media player is also disclosed.

### FIELD OF INVENTION

This invention relates to a portable media player, and refers particularly, though not exclusively, to a portable media player that facilitates karaoke and also allows the functional connection of external sound composition devices.

### BACKGROUND

At present, portable media players are primarily play-back devices. The only input a user has access to relates to the selection of their preferred settings like EQ and skins, and the selection of preferred songs or media content, such as, for example, images, movies, music videos, and filmlets. Currently, the facility of being able to create original compositions or modify existing songs is lacking from portable media players. In this regard, user involvement with the portable media player is minimal. A more involving experience between a user and a portable media player is lacking.

### SUMMARY

There is provided a portable media player including: a non-volatile memory; a processor for playing back media files stored in the memory; a display unit for displaying information from the media files stored in the memory; a MIDI synthesizer coupled to the processor; a sound input for passing sound signals through an analog-digital converter and, subsequently, the synthesizer; a sound output for transmitting sound signals from the synthesizer; and a port for coupling a sound composition apparatus to the media player. Preferably, the sound composition apparatus is also for passing digital signals through the synthesizer. The port for coupling the sound composition apparatus may be chosen from P/S 2, USB, IEEE 1394 Firewire or a customised connector. Connection of the sound composition apparatus may also be wirelessly where the port is a transceiver using protocols such as, for example, UWB USB wireless, Bluetooth, infrared and radio frequency.

It is preferable that the non-volatile memory device is either solid state memory or a hard disk drive. The memory may store signals that have been input into the media player subsequent to passing through the processor. The display unit may preferably be screens such as, for example, TFT, LCD and OLED. The information displayed on the screens may include duration of file playback, file metadata, still images, moving images, lyrics of a song, or a combination of them.

It is preferable that the sound input is able to have connected thereto a sound input apparatus such as, for example, a microphone; and it is preferred that to the sound output is able to have connector thereto at least one earphone, at least one earpiece of a headphone or at least one speaker. It is advantageous that the sound output includes an amplifier. It is most preferable that the MIDI synthesizer provides automatic accompaniment depending on the note and pitch of the sound inputs. Advantageously, the MIDI synthesizer includes controls to alter the pitch and tone of played back media files stored in the memory device of the portable media player. It is also preferable that the processor includes a decoder.

Preferably, the sound composition apparatus is, for example, a MIDI keyboard, an alphanumeric keyboard, a breath rate detection module, a string module, or a combination of them.

There is also provided a breath rate detection module able to be used with the portable media player. The breath rate detection module includes: a hollow tube for the channeling of air into the module; a processor to determine the speed, path and volume of air passing through the hollow tube into the module; and a connector coupled to the processor for a functional connection to the portable media player. It is preferable that the processor of the breath rate detection module is able to send signals to the portable media player to play back sounds of weird instruments such as, for example, trumpet, saxaphone, trombone, clarinet, oboe, bassoon, horn, recorder, flute and tuba. The signals passing through the synthesizer of the media player may also be fed back into the processor of the breath rate detection module.

A method of composing and storing music using the portable media player is also disclosed. The method may include entering signals into the media player via the port and/or the sound input; passing the signals through the synthesizer prior to the processor of the media player; and finally storing the processed signals in the memory device.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows an overview of a preferred embodiment;

FIG. 2 shows a bottom view of the preferred embodiment;

FIG. 3 shows a schematic diagram of the preferred embodiment;

FIG. 4 shows a schematic diagram of a breath rate detection module; and

FIG. 5 shows a flow chart of the operation of the breath rate detection module.

### DESCRIPTION OF PREFERRED EMBODIMENTS

There is shown a schematic diagram of a preferred embodiment of the present invention in FIG. 3. A portable media player 20 is shown. The portable media player 20 includes a non-volatile memory 42. The non-volatile memory device 42 may be selected from either solid state memory such as, for example, flash memory or a hard disk drive of a preferred disk diameter. The size of the memory may range from several kilobytes to hundreds of tetrabytes.

The portable media player 20 may also include a processor 44 for playing back media files stored in the memory device 42. The media files processed by the processor 44 may include one or more of music, image and video content. The processor 44 may include a decoder. There is also a display unit 40 for displaying information about the media files stored in the memory device 42. The display unit may be a type of screen such as, for example, TFT, LCD or OLED. Cost, image quality and battery consumption levels may be criteria used to determine the type of screen employed in the portable media player 20. The information displayed in the display unit 40 may include duration of file playback, file metadata, still images, moving images, lyrics of a song, or a combination of them. This facilitates the use of the portable media player 20 as a karaoke machine.

There may also be a MIDI synthesizer 46 in the portable media player 20. The synthesizer 46 may be coupled to the processor 44. The MIDI synthesizer 46 may have controls to adjust/modify the playback of the media content stored in the memory 42. For example, the pitch and tone of the music played back from the stored media files may be altered with the controls of the MIDI synthesizer 46.

A sound input 48 that passes sound signals through an analog-digital converter 45, following that into the MIDI synthesizer 46 and subsequently into the memory device 42 may also be included in the portable media player 20. The converter 45 performs the conversion of analog sound signals prior to subsequent signal processing. The sound input 48 may be able to have connected thereto a microphone or other suitable apparatus. The microphone may be a separate microphone connectable to the portable media player 20 or it may be a microphone integrated in the portable media player 20. The sound input device 48 may include an analog-digital converter incorporated within.

A sound output 52 that transmits sound signals from the MIDI synthesizer 46 may also be included in the portable media player 20. The sound output 52 may be able to have connected to it at least one earphone, at least one earpiece of a headphone or at least one speaker. The portable media player 20 may have external sound outputs 52 or the sound output 52 may be an incorporated component. The sound output 52 may also include an amplifier.

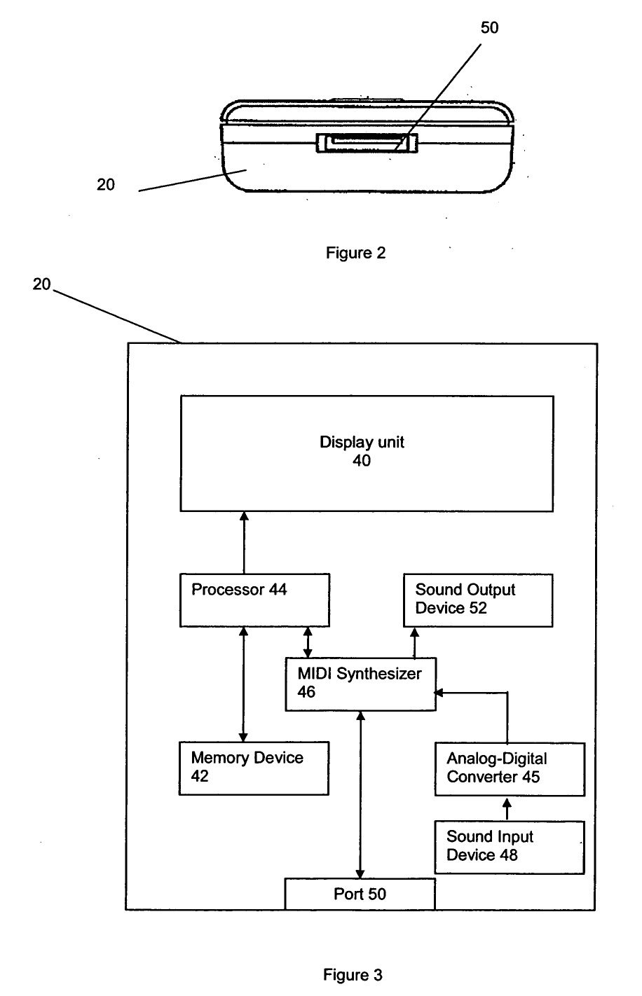

The portable media player 20 may also have a port 50 for the coupling of a sound composition apparatus to the portable media player 20. The port 50 may be standard sockets such as, for example, P/S 2, USB, and IEEE 1394 Firewire. The port 50 may also house transceivers for wireless protocols such as, for example, UWB USB wireless, Bluetooth, infrared, and radio frequency. Alternatively, port 50 may be a socket for at least one customised connector. FIG. 2 shows a preferred embodiment for the position of the port 50 in a base of the portable media player 20, although it is to be noted that the positioning of the port 50 on the portable media player 20 may be located at any feasible position on the portable media player 20.

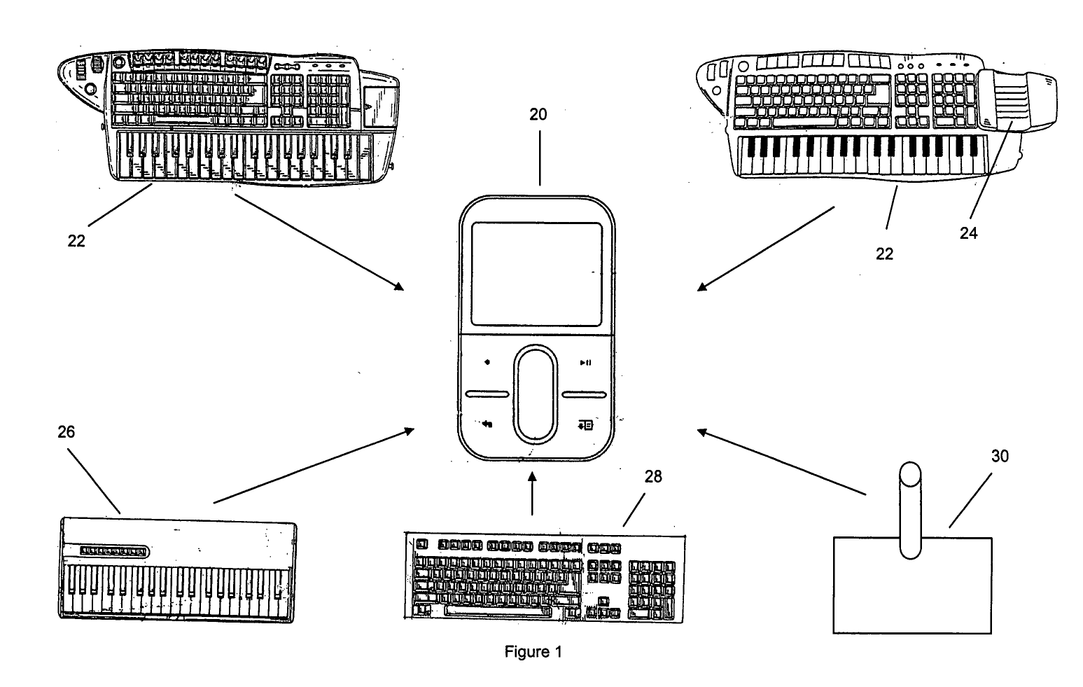

Referring to FIG. 1, there is shown different types of sound composition apparatus that may be connectable to the portable media player 20, although it is to be noted that the representation of devices is not exhaustive and may include further similar devices. Creative Technology's Prodikeys 22 may be one of the sound composition apparatus that may be connectable to the portable media player 20 through the port 50. A string module 24 integrated with the Prodikeys 22 may also be connectable to the portable media player 20 through the port 50. Alternatively, the string module 24 may also be independently connectable to the portable media player 20 through the port 50. A MIDI keyboard 26 and an alphanumeric keyboard 28 are also some of the sound composition apparatus that may be connectable to the portable media player 20 through the port 50. A breath rate detection module 30 may also be connectable to the portable media player 20 through the port 50. Combinations of the aforementioned sound composition apparatus may also be connectable to the portable media player 20. The use of a hub for the port 50 may only be necessary in the instance when there is one port 50 in the media player 20. Firmware in the portable media player 20 may be able to identify the sound composition apparatus connected to the portable media player 20 through the port 50 and the MIDI synthesizer 46 may be able to generate varied sounds compatible with the connected apparatus. For example, each key on the alphanumeric keyboard 28 may be designated a predetermined sound/tone/pitch which the MIDI synthesizer 46 may generate. The sound composition apparatus may preferably generate digital signals. Analog instruments may have their signals converted to digital format prior to being input into the media player 20.

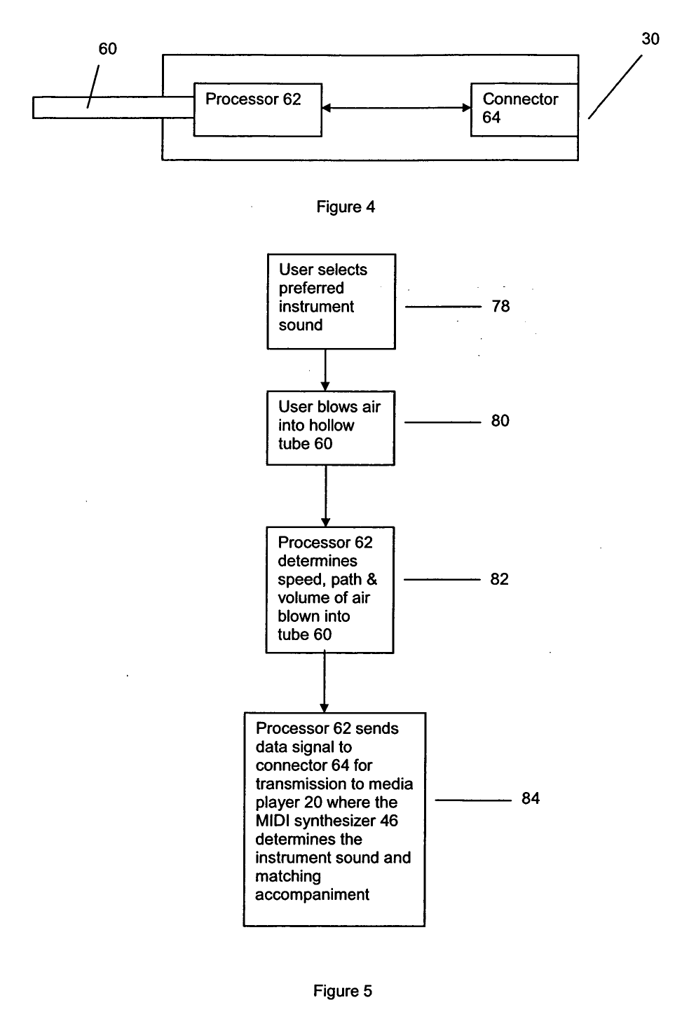

A schematic diagram of the breath rate detection module 30 used with the portable media player 20 is provided in FIG. 4. In addition, FIG. 5 shows a flow chart detailing the operation of the breath rate detection module 30. There is provided a hollow tube 60 for the channeling of air into the module 30. A user chooses a preferred instrument sound (78) by selecting appropriate settings for a processor 62 and blows into the hollow tube 60 (80). The module 30 includes the processor 62 to determine the speed, path and volume of air passing through the hollow tube 60 into the module 30 (82). The path of the air passing through the tube 60 may be varied by covering slits/holes located on the tube 60 or diversions to the air flow may be introduced as per a valved instrument such as, for example, a trumpet. The processor 62 may be coupled to sensors at the slits/holes to determine the pitch/octave of the sound signal generated. The processor 62 also controls the instrument sound in accordance with the selected preference. The processor 62 of the module 30 may control the play back of sounds of wind instruments such as, for example, trumpet, trombone, tuba, horn, saxaphone, flute, clarinet, oboe, bassoon or recorder. A connector 64 included in the module allows for a functional connection to the portable media player 20 through the port 50. The processor 62 sends a data signal to the connector 64 for transmission to the media player 20 through a functional connection to the portable media player 20 through the port 50 (84). A digital signal from the module 30 is passed into the MIDI synthesizer 46 which processes the signal and determines both the instrument sound and a matching accompaniment. The accompaniment generated by the synthesizer 46 may depend on the note and pitch of the sound signals being input into the media player 20. The MIDI synthesizer 46 of the media player 20 may also feedback a signal to the processor 62 to electronically adjust the sound signal output from the processor 62.

It should be noted that the circuitry in the module 30 should be shielded from the breath (and accompanying moisture) of the user to prevent damage to the circuitry of the module 30.

During the use of the portable media player 20 as a karaoke device, a user may be able to select a media file stored in the memory device 42 and sing along to a song with moving images and lyrics being shown on the display unit 40 when a command to execute the media file is selected. The user may sing into a microphone attached to a built into the sound input 48 and, after conversion of the sound signal from analog to digital by the converter 45, the MIDI synthesizer 46 automatically provides accompaniment to the various notes generated by the voice of the user. The MIDI synthesizer 46 is also able to alter the pitch and tone of the played back media file stored in the memory device 42 to better suit the voice of the user while kara-oking. The portable media player 20 may also transmit the user's singing after processing by the MIDI synthesizer 46 via the sound output 52. In addition, the user's singing with automatic accompaniment may also be recorded onto the memory 42 for playback when required. Consequently, the user may also sing and simultaneously use the sound composition apparatus connected to the portable media player 20 to create and record original musical compositions or enhance existing pieces of music.

The portable media player 20 may also be able to provide automatic accompaniment for a user that hums a random tune into the sound input 48. In such an instance, playback of a media file stored in the memory 42 and the attachment of sound composition apparatus are not mandatory.

There is also disclosed a method of composing and storing music using the portable media player 20 as per the preferred embodiment of the present invention. Firstly, signals are entered into the media player 20 via the port 50 and/or the sound input 48 of the media player 20. Then the signals are passed through the synthesizer 46 prior to processing and/or decoding in the processor 44. Finally, the processed signals are stored in the memory 42 for playback at a later occasion. Thus, the user may sing/hum while playing on a sound composition apparatus and a composition with accompaniment provided by the synthesizer 46 may be stored in the memory 42.

Whilst there has been described in the foregoing description preferred embodiments of the present invention, it will be understood by those skilled in the technology concerned that many variations or modifications in details of design or construction may be made without departing from the present invention.

1. A portable media player including:
a non-volatile memory;
a processor for playing back media files stored in the memory;
a display unit for displaying information from the media files stored in the memory;
a MIDI synthesizer coupled to the processor;
a sound input for passing sound signals through an analog-digital converter and, subsequently the synthesizer;
a sound output for transmitting sound signals from the synthesizer; and a port for the coupling of a sound composition apparatus to the media player, wherein the sound composition apparatus also passes signals through the synthesizer.

2. The portable media player as claimed in claim 1, wherein the non-volatile memory is selected from the group consisting of: solid state memory and a hard disk drive.

3. The portable media player as claimed in claim 1, wherein the display unit is a screen selected from the group consisting of: TFT, LCD and OLED.

4. The portable media player as claimed in claim 1, wherein the information for display is selected from the group consisting of: duration of file playback, file metadata, still images, moving images, lyrics of a song, and a combination of them.

5. The portable media player as claimed in claim 1, wherein the sound input has attached thereto a microphone.

6. The portable media player as claimed in claim 1, wherein the sound output device is selected from the group consisting of: at least one earphone, at least one earpiece of a headphone and at least one speaker.

7. The portable media player as claimed in claim 1, wherein the port for coupling a sound composition device is selected from the group consisting of: P/S 2, USB, IEEE 1394 Firewire and a customised connector.

8. The portable media player as claimed in claim 1, wherein the port is a transceiver for wireless protocols selected from the group consisting of: UWB USB wireless, Bluetooth, infrared and radio frequency.

9. The portable media player as claimed in claim 1, wherein the sound composition apparatus is selected from the group consisting of: a MIDI keyboard, an alphanumeric keyboard, a breath rate detection module, a string module, and a combination of them.

10. The portable media player as claimed in claim 1, wherein the MIDI synthesizer provides automatic accompaniment for all sound inputs.

11. The portable media player as claimed in claim 1, wherein the sound output includes an amplifier.

12. The portable media player as claimed in claim 1, wherein the processor includes a decoder.

13. The portable media player as claimed in claim 1, wherein the sound composition apparatus outputs digital signals.

14. The portable media player as claimed in claim 9, wherein the breath rate detection module comprises:
a hollow tube for the channeling of air into the module;
a processor to determine the speed, path and volume of air passing through the hollow tube into the module; and
a connector coupled to the processor for a functional connection to the portable media player.

15. The portable media player as claimed in claim 14, wherein the processor of the breath rate detection module is able to send signals to the portable media player to play back sounds of wind instruments.

16. The portable media player as claimed in claim 15, wherein the wind instruments are selected from the group comprising: trumpet, trombone, horn, tuba, saxaphone, flute, clarinet, oboe, bassoem and recorder.

17. The portable media player as claimed in claim 1, wherein the MIDI synthesizer includes controls to alter the pitch and tone of the played back media files stored in the memory.

18. The portable media player as claimed in claim 1, wherein the memory stores signals that have been input into the media player subsequent to passing through the processor.

19. The portable media player as claimed in claim 10, wherein the accompaniment is dependent on parameters of input signals selected from the group consisting of: note and pitch.

20. A method of composing and storing music using the portable media player as claimed in claim 1, including:
entering signals into the media player via the port and/or the sound input;
passing the signals through the synthesizer prior to the processor; and
storing the processed signals in the memory.

21. A breath rate detection module used with the portable media player as claimed in claim 1, wherein the breath rate detection module comprises:
a hollow tube for the channeling of air into the module;
a processor to determine the speed, path and volume of air passing through the hollow tube into the module; and
a connector coupled to the processor for a functional connection to the portable media player.

22. The breath rate detection module as claimed in claim 21, wherein the processor of the breath rate detection module is able to send signals to the portable media player to play back sounds of wind instruments.

23. The breath rate detection module as claimed in claim 22, wherein selected from the group comprising: trumpet, trombone, horn, tuba, saxaphone, flute, clarinet, oboe, bassoon and recorder.

24. The breath rate detection module as claimed in claim 21, wherein a signal from a MIDI synthesizer of the portable media player is fed back to the processor to adjust the output from the breath rate detection module.
